(19) United States
(12) Patent Application Publication
(10) Pub. No.: US 2013/0095277 A1
(43) Pub. Date: Apr. 18, 2013

(54) FIBER BASE MATERIAL AND INTERIOR MATERIAL USING THE SAME

(71) Applicants: Toyota Boshoku Kabushiki Kaisha, Aichi-ken (JP); K-Plasheet Corporation, Chiba-ken (JP)

(72) Inventors: Tsutomu TAKAGI, Gifu-shi (JP); Tetsuya NAKAMURA, Ichinomiya-shi (JP); Yosuke TAGAMI, Kagamihara-shi (JP); Seiji HANATANI, Chiba-shi (JP); Hideaki YAMASHITA, Chiba-shi (JP)

(73) Assignees: K-PLASHEET CORPORATION, Chiba-ken (JP); TOYOTA BOSHOKU KABUSHIKI KAISHA, Aichi-ken (JP)

(21) Appl. No.: 13/645,732

(22) Filed: Oct. 5, 2012

(30) Foreign Application Priority Data
Oct. 14, 2011 (JP) 2011-227307

(51) Int. Cl. B32B 5/14; B32B 5/22; B32B 5/16

(52) U.S. Cl. 428/98; 428/221

(57) ABSTRACT

The present plate-like fiber base material has fibers and a thermoplastic resin. The fibers are bound by the thermoplastic resin, and the fiber base material includes a plurality of areas that differ in basis weight. The fiber base material may have a cut, and the basis weight of a cut-surrounding area positioned around the cut may be higher than that of an area positioned around the cut-surrounding area. The present interior material has the fiber base material and a surface layer that is disposed on one side of the fiber base material.

The present application claims priority under 35 U.S.C. §119 of Japanese Patent Application No. 2011-227307, filed on Oct. 14, 2011, the disclosure of which is expressly incorporated by reference herein in its entirety.

### BACKGROUND OF THE INVENTION

1. Field of the Invention

The present invention relates to a fiber base material and an interior material using the same.

2. Related Art

A fiber base material (e.g., plate-like fiber base material) has been widely used as an automotive interior material (e.g., floor trim, roof trim, and door trim), a construction material (e.g., floor, ceiling, and carpet), and the like in order to achieve heat insulation, sound insulation, buffering, and the like.

The fiber base material has been reduced in weight in order to reduce environmental impact, cost, and the like. However, the rigidity of the fiber base material may decrease as a result of reducing the weight of the fiber base material. Therefore, it may be difficult to provide the fiber base material with sufficient rigidity that can endure handling (i.e., handling rigidity). A further reduction in weight of the fiber base material has been limited from the viewpoint of handling rigidity. JP-A 2004-217829 and JP-A H8-25489 disclose technology that improves the rigidity of the fiber base material.

### SUMMARY OF THE INVENTION

JP-A 2004-217829 discloses a stampable sheet that is obtained by drying and needling a sheet obtained by sheet-forming in which reinforcing fibers are bound by a thermoplastic resin. JP-A H8-25489 discloses a stampable sheet that improves rigidity by utilizing reinforcing glass fibers having a large diameter and reinforcing glass fibers having a small diameter in combination. The rigidity of the sheet material can be improved by the technology disclosed in JP-A 2004-217829 and JP-A H8-25489. However, technology that can achieve a further reduction in weight and an improvement in rigidity in combination has been desired.

An object of the present invention is to provide a fiber base material that is reduced in weight and provided with sufficient handling rigidity, and an interior material using the same.

In order to the above-mentioned problem, the fiber base material of the present invention is characterized that the fiber base material includes fibers and a thermoplastic resin, that the fibers are bound by the thermoplastic resin, and that the fiber base material includes a plurality of areas that differ in basis weight. And the interior material of the present invention has a surface layer that is disposed on one side of the fiber base material.

According to the plate-like fiber base material of the present invention, the fiber base material can be reduced in weight without impairing handling rigidity. In particular, the handling rigidity can be efficiently obtained while reducing the total weight of the fiber base material by locally increasing the basis weight in an area in which rigidity is required.

In the case where the basis weight of a cut-surrounding area positioned around a cut is higher than that of an area positioned around the cut-surrounding area, the handling rigidity of the fiber base material can be more effectively improved. Specifically, a decrease in rigidity due to the cut can be compensated for by increasing the basis weight of the cut-surrounding area, and a change in rigidity can be reduced by decreasing the basis weight of the area positioned around the cut-surrounding area, so that excellent handling rigidity can be obtained.

In the case where the basis weight gradually decreases from a first area having a given basis weight toward a second area having a basis weight lower than that of said first area, a formation of a starting point in which the fiber base material is bent can be suppressed (since the basis weight gradually changes), so that excellent handling rigidity can be obtained.

According to the interior material of the present invention, the interior material can be reduced in weight without impairing handling rigidity. In particular, the interior material can also be provided with excellent design since a change in thickness and an undulation of the surface are suppressed.

The fiber base material and interior material of the present invention may be applied to various fields such as an automotive material and a construction material. The fiber base material of the invention may widely be used as an automotive material, a construction material, and the like. In particular, the fiber base material may be useful as an automotive interior material. For example, the fiber base material of the invention may suitably be used as a core material of an interior material (e.g., floor trim, roof trim, and door trim).

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a plan view illustrating a fiber base material according to first embodiment;

FIG. 2 is a perspective view illustrating an automotive interior material having a fiber base material;

FIG. 3 is a perspective view illustrating a fiber base material according to second embodiment;

FIG. 4 is a perspective view illustrating a fiber base material according to third embodiment;

FIG. 5 is a plan view illustrating a fiber base material according to fourth embodiment;

FIG. 6 is a graph showing a change in basis weight of a fiber base material in the widthwise direction;

FIG. 7 is a cross-sectional view illustrating an interior material according to fifth embodiment;

FIG. 8 is an explanatory view illustrating a method by fabricating a fiber base material by stacking webs; and

FIG. 9 is a perspective view illustrating a fiber base material according to sixth embodiment.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

### First Embodiment

The fiber base material 1 according to the first embodiment of the invention is described below with reference to drawings.

The fiber base material 1 is a plate-like fiber base material in which fibers are bound by a thermoplastic resin. The fiber base material 1 is characterized by having a plurality of areas that differ in basis weight.

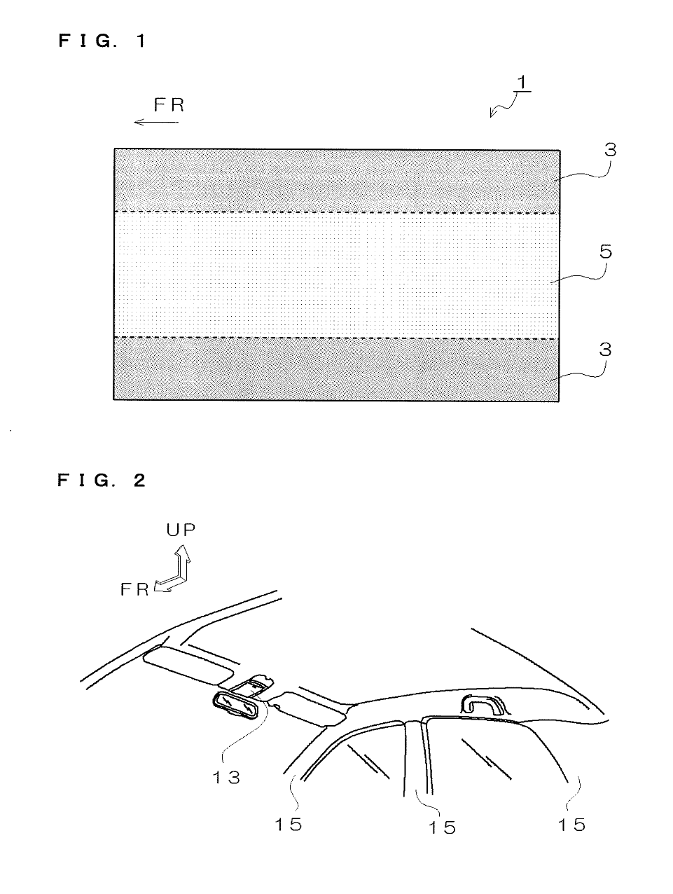

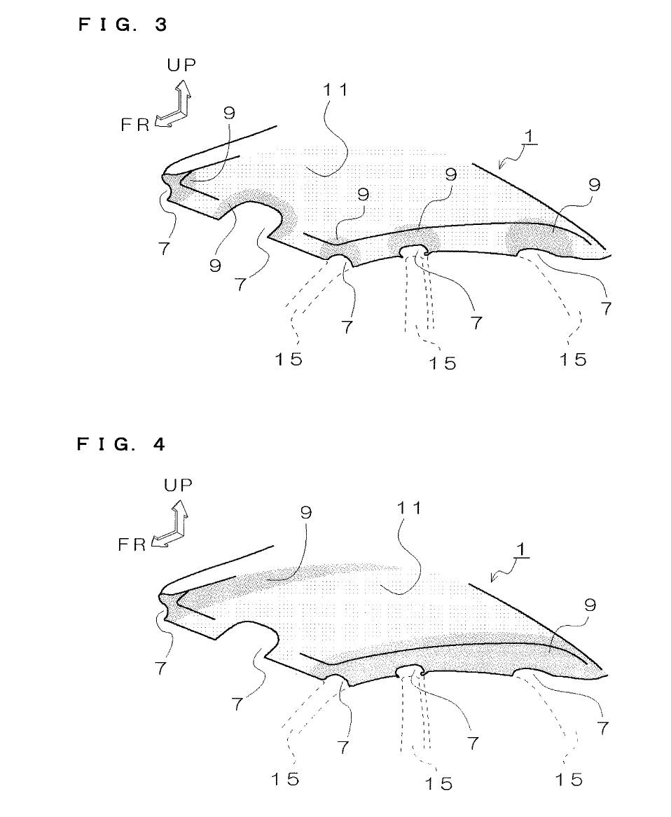

As illustrated in FIG. 1, the fiber base material 1 according to the first embodiment includes a first area 3 having a high basis weight, and a second area 5 having a basis weight lower than that of the first area 3. Note that the difference in hatching density in FIG. 1 indicates the difference in basis weight. A high hatching density indicates a high basis weight. This also applies to FIGS. 3 to 5. The arrow FR in FIG. 1 indicates the front side when the fiber base material 1 is used as an automotive interior material.

In the fiber base material 1 according to the first embodiment, the first area 3 having a high basis weight is provided on each side of the fiber base material 1 in the shape of a strip. Therefore, each side of the fiber base material 1 exhibits high rigidity, so that the entire fiber base material 1 exhibits high rigidity.

A conventionally known fiber base material is curved or bent (i.e., exhibits poor workability) when the worker holds or carries the fiber base material during assembly or the like. According to the first embodiment, bending can be suppressed (i.e., rigidity can be improved) by disposing the first area having a high basis weight on each side of the fiber base material 1 in the shape of a strip, so that the handling capability can be significantly improved.

The basis weights of both areas are not particularly limited and the basis weight of the first area 3 having higher basis weight is preferably in the range from 100 to 1,000 g/m², more preferably from 200 to 900 g/m², and particularly from 300 to 600 g/m².

The basis weight of the second area 5 having lower basis weight is preferably in the range from 100 to 1,000 g/m², more preferably from 150 to 800 g/m², and particularly from 200 to 500 g/m².

Since the fiber base material 1 is widely applied to various fields, the thickness thereof is not particularly limited. The fiber base material may have an appropriate thickness depending on the application and the like. The thickness of the fiber base material 1 is usually in the range from 0.5 to 200 mm, and particularly from 0.5 to 80 mm. When the thickness is in the range from 0.5 to 200 mm, the fiber base material 1 exhibits sufficient strength and the like in various applications, and can be used as a lightweight member.

In the first embodiment, the number of areas that differ in basis weight is set to two (i.e., first area 3 and second area 5). The number (types) of areas that differ in basis weight is not particularly limited and may be three or more.

The fibers that form the fiber base material 1 are bound by the thermoplastic resin to provide the fiber base material 1 with rigidity, and function as reinforcing fibers for the fiber base material. Type, length, diameter, and the like are not particularly limited.

An inorganic fiber, organic fiber, or inorganic-organic composite fiber may be used as the fiber. Examples of the inorganic fiber include glass fibers, carbon fibers (e.g., PAN-based carbon fibers, pitch-based carbon fibers, and cellulose-based carbon fibers), metal fibers (e.g., aluminum fibers and stainless steel fibers), ceramic fibers (basalt fibers, silicon carbide fibers, and silicon nitride fibers), and the like. Examples of the organic fiber include synthetic fibers, natural fibers, and the like. Examples of the synthetic fibers include polyester-based fibers, polyamide-based fibers (e.g., aramid fibers), polyolefin-based fibers, acrylic fibers, vinylon-based fibers, and the like. Examples of the natural fibers include fibers derived from plants or animals. Specific examples of the natural fibers include plant-based fibers derived from various plants such as kenaf, Manila hemp, sisal, jute hemp, raw cotton, ganpi, Edgeworthia chrysantha, banana, pineapples, coconut palm, corn, sugarcane, bagasse, coconut, papyrus, reed, esparto, sabai grass, wheat, rice plant, bamboo, and conifers.

When the inorganic fibers are used, the surface of the fibers may be subjected to a surface treatment for improving affinity to the thermoplastic resin. This surface treatment leads to improved bindability when using the thermoplastic resin. Examples of the surface treatment include a coupling treatment (e.g., silane coupling treatment).

The length of the fiber is usually in the range from 1 to 100 mm, preferably from 3 to 70 mm from the viewpoint of obtaining high rigidity, and more preferably from 3 to 50 mm from the viewpoint of basis weight control. On the other hand, the diameter of the fiber is usually in the range from 1 to 30 μm, preferably from 5 to 25 μm from the viewpoint of obtaining high rigidity, and more preferably from 7 to 25 μm from the viewpoint of basis weight control.

Note that the term “length” of the fibers used herein refers to a value obtained by measuring the length of one fiber that has been randomly selected and is extended linearly in accordance with JIS L 1015 (direct method), and the term “diameter” of the fibers used herein refers to a value obtained by measuring the diameter of the center area (in the lengthwise direction) of the fiber subjected to the fiber length measurement using an optical microscope.

The thermoplastic resin constituting the fiber base material 1 binds a plurality of fibers to maintain a shape and provides the fiber base material 1 with rigidity. The thermoplastic resin functions as a binder for the fibers. Examples of the thermoplastic resin include a polyolefin-based resin, a polyester-based resin, a polystyrene, a poly vinyl chloride, a polyacrylic resin, a polyamide-based resin, a polycarbonate resin, an ABS resin, a polyacetal resin, and the like. These resins may be used singly or in combination of two or more types thereof.

Examples of the polyolefin-based resin include a polyolefin resin such as polypropylene and polyethylene; a polyolefin-based copolymer such as ethylene-vinyl chloride copolymer and ethylene-vinyl acetate copolymer; a polyolefin-based thermoplastic elastomer such as ethylene-propylene copolymer and ethylene-propylene-diene copolymer; a modified polyolefin resin such as a polyolefin resin modified with a carboxylic group or an acid anhydride group; and the like.

Examples of the polyester-based resin include an aliphatic polyester resin such as polylactic acid and polycaprolactone; an aromatic polyester resin such as polyethylene terephthalate.

Examples of the polyacrylic resin include a methacrylate and an acrylate.

In the present invention, a polyolefin-based resin is preferable from viewpoints of moldability and low specific gravity. A polyolefin resin such as polypropylene and polyethylene is more preferable from viewpoint of rigidity and modulus of elasticity.

The content ratio of the fibers in the fiber base material 1 is usually in the range from 10% to 65% by weight based on 100% by weight of the total content of the fibers and the thermoplastic resin included in the fiber base material 1. The content ratio is preferably in the range from 15% to 55% by weight from the viewpoint of obtaining high rigidity.

The fiber base material 1 may optionally contain various additives. Examples of the additives include a blowing agent, an antioxidant, a UV absorber, a lubricant, a flame retardant, a flame retardant aid, a softener, an inorganic or organic filler that improves impact resistance, heat resistance, and the like of the fiber base material, an antistatic agent, a coloring agent, a plasticizer, and the like.

The fiber base material according to the first embodiment may be produced by an arbitrary method. For example, the fiber base material may be produced by the following method.

Specifically, a web including fibers and thermoplastic resin bodies is heated to melt the thermoplastic resin bodies included in the web, and then thermoplastic resin is solidified in a state in which the fibers are bound by the thermoplastic resin to obtain the fiber base material 1. The web may be obtained by an arbitrary method. The web may normally be obtained by utilizing a dry process described below, or a wet process that allows fibers and thermoplastic resin bodies to deposit in a dispersion medium (not illustrated in the drawings).

The dry process is a method in which the fibers and thermoplastic resin bodies (normally thermoplastic resin fibers are used in the dry process) are mixed in a gas phase, and mixture of the fibers and thermoplastic resin bodies are fallen downward and deposited to form a web. On the other hand, the wet process is a method in which a dispersion including the fibers and thermoplastic resin bodies (thermoplastic resin fibers or particles) in a medium is subjected to sheet-forming to form a web. A web obtained by the dry process or wet process may optionally be subjected to needling.

The forming method of a plurality of areas that differ in basis weight is not particularly limited for the fiber base material 1. For example, in the case of the dry process, an additional web 21 having a basis weight identical with or different from that of a basic web 20 including fibers and thermoplastic resin bodies and having a predetermined basis weight may be stacked on the basic web 20, and the resulting stacked web may be heated and cooled to form a plurality of areas that differ in basis weight (see FIG. 8). A plurality of additional webs may optionally be stacked in layers. After that, the thermoplastic resin bodies in the stacked web are molten and the fibers are bound by the molten thermoplastic resin. The fiber base material 1 is then obtained by solidifying the thermoplastic resin.

The configuration of the additional web is not particularly limited. The additional web normally includes fibers and thermoplastic resin bodies in the same manner as the basic web. The stacked web may optionally be subjected to needling before heating. When the stacked web is heated, the stacked web may optionally be pressurized simultaneously with or after heating.

### Second Embodiment

The fiber base material 1 according to the second embodiment of the invention is described below with reference to FIGS. 2 and 3. The automotive interior material of FIG. 2 can have the fiber base material 1 of FIG. 3. Note that the same elements as those described in connection with the first embodiment are indicated by identical signs, and description of the structure and the advantageous effects is omitted. The difference in hatching density indicates the difference in basis weight in the same manner as in FIG. 1. A high hatching density indicates a high basis weight. The arrow FR in FIGS. 2 and 3 indicates the front side of an automobile, and the arrow UP indicates the upper side. This also applies to FIG. 4.

The fiber base material 1 has a cut 7, and is configured so that the basis weight of a cut-surrounding area 9 positioned around the cut 7 is higher than that of an area 11 positioned around the cut-surrounding area 9. Each cut 7 is formed in the fiber base material 1 at a position corresponding to the position of each pillar 15 or overhead console 13 when the fiber base material 1 is used as an automotive ceiling material (see FIG. 3). In the case where the fiber base material 1 has the cut 7, load or stress due to curving tends to be concentrated at the cut 7 when the worker holds or carries the fiber base material 1 during assembly or the like. As a result, the fiber base material may be bent at the cut 7. According to the second embodiment, bending can be suppressed (i.e., rigidity can be improved) by increasing the basis weight of the cut-surrounding area 9 positioned around the cut 7, so that the handling capability can be significantly improved.

Note that the cut-surrounding area 9 is formed to surround the cut 7 (see FIG. 3). The width of the cut-surrounding area 9 is not particularly limited and is preferably more than 0 cm and 30 cm or less, more preferably more than 0 cm and 20 cm or less, and particularly more than 0 cm and 15 cm or less.

### Third Embodiment

The fiber base material 1 according to the third embodiment of the invention is described below with reference to FIG. 4. The automotive interior material of FIG. 2 can have the fiber base material 1 of FIG. 4. Note that the same elements as those described in connection with the second embodiment are indicated by identical signs, and description of the structure and the advantageous effects is omitted.

The fiber base material 1 used as an automotive ceiling material has a configuration in which an area having a high basis weight is provided on each side of the fiber base material 1 in the shape of a strip (i.e., each side of the fiber base material 1 exhibits high rigidity) in the same manner as the fiber base material 1 illustrated in FIG. 1. A cut 7 is formed in the area having a high basis weight at a position corresponding to the position of each pillar 15. Specifically, each cut 7 that corresponds to each pillar 15 is formed in the area having a high basis weight. The basis weight of a cut-surrounding area 9 positioned around each cut 7 is higher than that of an area 11 positioned around the cut-surrounding area 9.

Load or stress tends to be concentrated at each cut 7 formed in the fiber base material 1 during handling (e.g., assembly). According to the third embodiment, bending can be suppressed (i.e., rigidity can be improved) by increasing the basis weight of the cut-surrounding area 9 positioned around the cut 7, so that the handling capability can be significantly improved.

Note that the cut-surrounding area 9 is formed to surround each cut 7 that is formed at a position corresponding to each pillar 15 (see FIG. 4). The width of the cut-surrounding area 9 is not particularly limited and is preferably more than 0 cm and 40 cm or less, more preferably more than 0 cm and 30 cm or less, and particularly more than 0 cm and 25 cm or less.

### Fourth Embodiment

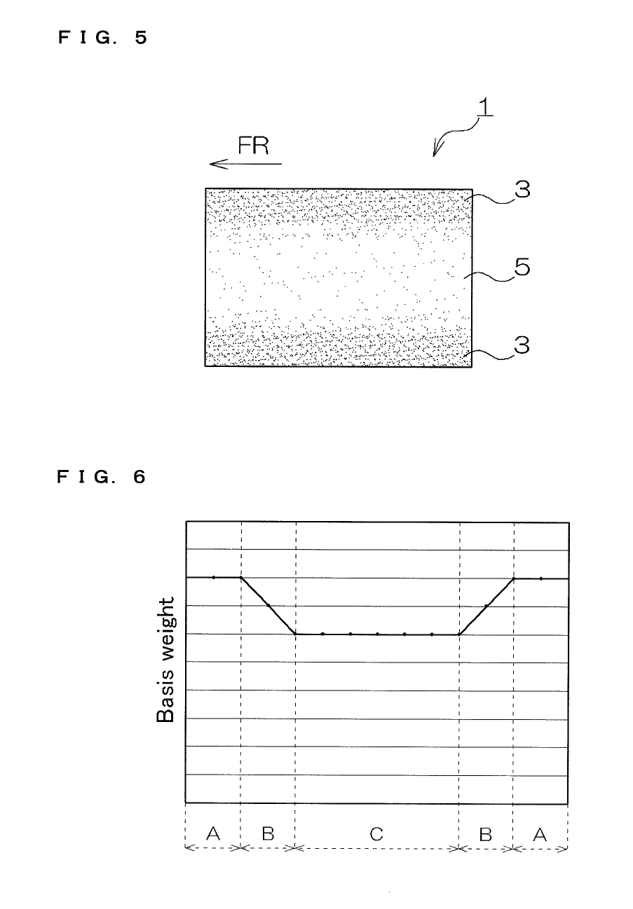

The fiber base material 1 according to the fourth embodiment of the invention is described below with reference to FIGS. 5 and 6. Note that the same elements as those described in connection with the first embodiment are indicated by identical signs, and description of the structure and the advantageous effects is omitted.

The fiber base material 1 according to the fourth embodiment is formed so that the basis weight gradually decreases from a first area 3 having a given basis weight toward a second area 5 having a basis weight lower than that of the first area 3 (see FIG. 5).

FIG. 6 illustrates the change in basis weight in the widthwise direction. In this FIG. 6, “A” indicates the basis weight of the first area 3, and “C” indicates the basis weight of the second area 5. In FIG. 6, the basis weight gradually decreases from the first area 3 toward the second area 5 in an area indicated by “B”.

When the basis weight gradually decreases from the first area 3 toward the second area 5, occurrence of a bending point can be reduced as compared with the case where the basis weight rapidly changes from the first area 3 to the second area 5. According to the fourth embodiment, bending can thus be further suppressed, so that the handling capability can be significantly improved.

### Fifth Embodiment

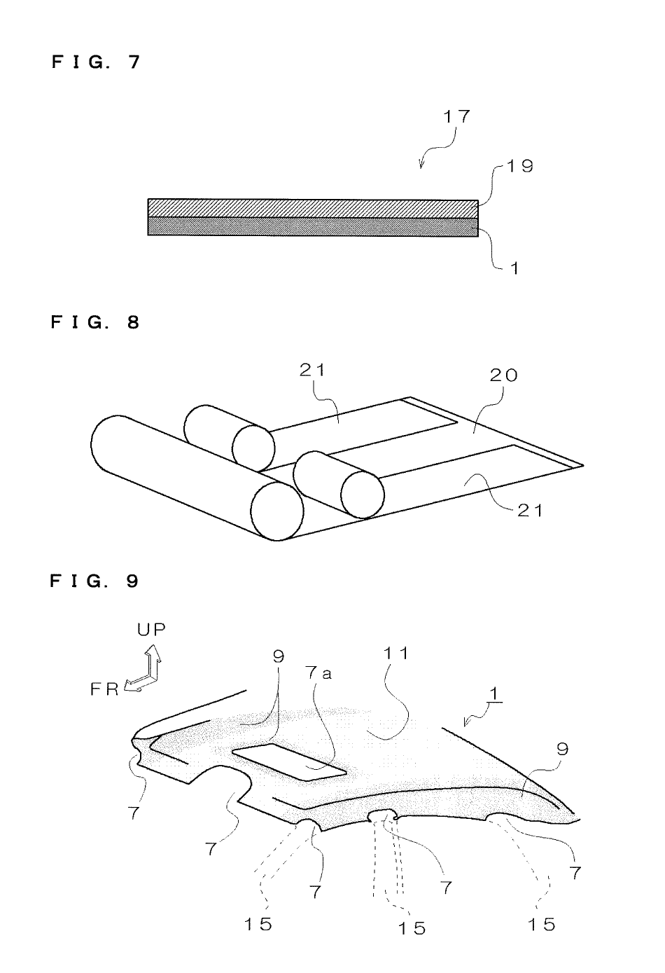

The interior material 17 according to the fifth embodiment of the invention is described below with reference to FIG. 7. Note that the same elements as those described in connection with the first embodiment are indicated by identical signs, and description of the structure and the advantageous effects is omitted.

The interior material 17 includes a fiber base material 1, and a surface layer 19 that is disposed on one side of the fiber base material 1 (see FIG. 7). The surface layer 19 may be consisting of only one layer, and may be consisting of two or more layers.

Examples of the surface layer include a nonwoven fabric layer (e.g., design-side scrim layer), a woven fabric layer (e.g., design-side knitted layer), an air-block film layer, an elastic layer (e.g., polyurethane foam layer), a background fabric layer, and the like. These layers may be used either alone or in combination.

Note that when the interior material 17 has an air-block film layer, the air-block film layer may be formed via an adhesive layer on the fiber base material 1.

### Sixth Embodiment

The fiber base material 1 according to the sixth embodiment of the invention is described below with reference to FIG. 9. The automotive interior material of FIG. 2 can have the fiber base material 1 of FIG. 9. Note that the same elements as those described in connection with the third embodiment are indicated by identical signs, and description of the structure and the advantageous effects is omitted.

The fiber base material 1 that is used as an automotive ceiling material has, as shown in FIG. 9, a configuration in which an area having a high basis weight is provided on each side of the fiber base material 1 in the shape of a strip, and a cut 7 is formed in the area having a high basis weight at a position corresponding to the position of each pillar 15 in the same manner as the fiber base material 1 illustrated in FIG. 4. An area having a high basis weight is also provided in a center area of the fiber base material 1, and a cut 7a (through-hole) that corresponds to a sunroof is formed in the area having a high basis weight that is provided in the center area of the fiber base material 1. The basis weight of a cut-surrounding area 9 positioned around each cut 7 or 7a is higher than that of an area 11 positioned around the cut-surrounding area 9.

Load or stress tends to be concentrated at each cut 7 or 7a formed in the fiber base material 1 during handling (e.g., assembly). According to the sixth embodiment, bending can be suppressed (i.e., rigidity can be improved) by increasing the basis weight of the cut-surrounding area 9 positioned around each cut 7 or 7a, so that the handling capability can be significantly improved.

The width of the cut-surrounding area 9 is not particularly limited and is preferably more than 0 cm and 40 cm or less, more preferably more than 0 cm and 30 cm or less, and particularly more than 0 cm and 25 cm or less.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

What is claimed is:

1. A plate-like fiber base material comprising fibers and a thermoplastic resin, said fibers being bound by said thermoplastic resin, said fiber base material including a plurality of areas that differ in basis weight.

2. The fiber base material according to claim 1, wherein said fiber base material having a cut, and wherein the basis weight of a cut-surrounding area positioned around said cut is higher than that of an area positioned around said cut-surrounding area.

3. The fiber base material according to claim 1, wherein the basis weight gradually decreases from a first area having a given basis weight toward a second area having a basis weight lower than that of said first area.

4. An interior material comprising said fiber base material according to claim 1, and a surface layer that is disposed on one side of said fiber base material.
